(19) United States
(12) Patent Application Publication
(10) Pub. No.: US 2015/0091808 A1
(43) Pub. Date: Apr. 2, 2015

(54) METHOD FOR PREVENTING FALSE ACTIVATION OF TOUCH PAD OF PORTABLE COMPUTER

(71) Applicant: TIANJIN FUNAYUANCHUANG TECHNOLOGY CO., LTD., Tianjin (CN)

(72) Inventors: PO-SHENG SHIH, New Taipei (TW); CHIEN-YUNG CHENG, New Taipei (TW); CHUN-LUNG HUANG, New Taipei (TW); PIN-LUNG LIN, New Taipei (TW)

(21) Appl. No.: 14/497,758

(22) Filed: Sep. 26, 2014

(30) Foreign Application Priority Data
Sep. 27, 2013 (CN) 201310448093.X

(51) Int. Cl. G06F 3/041; G06F 3/0354; G06F 3/02

(52) U.S. Cl. CPC G06F 3/0418; G06F 3/0213; G06F 3/03547
USPC 345/169

(57) ABSTRACT

A method for preventing a false activation of a touch pad of a portable computer is provided. The portable computer includes a display and a base assembly. The base assembly includes a keyboard and a touch pad. The keyboard includes keys and the touch pad has a touch area. In the method, the touch area is divided into a plurality of subareas. Each key corresponds to at least one subarea. A key input is detected. If the key input is detected, the at least one subarea corresponding to the inputting key are maintained as untouchable.

### CROSS-REFERENCE TO RELATED APPLICATIONS

This application claims all benefits accruing under 35 U.S.C. §119 from Chinese Patent Application No. 201310448093.X, filed on Sep. 27, 2013, the disclosure of which is incorporated herein by reference.

### FIELD

The present disclosure relates to a method for preventing a false activation of a touch pad, especially a touch pad of a large size used in portable computers.

### BACKGROUND

Advances in technology have enabled the size of personal computers to decrease. As a result, the use of portable computers, such as notebook computers, laptop computers, and notepad computers, is rapidly increasing. A typical notebook computer includes a display assembly and a base assembly with a keyboard and a touch pad. The touch pad is used for navigating a cursor control. The touch pad has a relative small size and is centered disposed below the keyboard to avoid causing unwanted or false activations of the touch pad.

However, functions of the touch pad of the notebook computer are gradually required to expand to handwriting, drawing, and gesture control. These needs result in the size of the touch pad becoming larger. However, a touch pad with a large size has some disadvantages, such as having the palm of a user falsely triggering the touch pad when typing on the keyboard, resulting in typing interference.

Therefore, there is a need to provide methods for preventing false activation of a touch pad of a portable computer.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a structural isometric view of an embodiment of an portable computer including a touch pad.

FIG. 2 is a flowchart of an embodiment of a method for preventing a false activation of the touch pad of the portable computer.

FIG. 3 is a diagrammatic view of an embodiment showing a corresponding relationship between keys of a keyboard and subareas of a touch area of the touch pad.

FIG. 4 is a diagrammatic view of an embodiment showing shapes of subareas in the touch area of the touch pad.

FIG. 5 is a diagrammatic view of an embodiment of one way of dividing a touch area on the touch pad.

FIG. 6 is a diagrammatic view of another embodiment of one way of dividing the touch area on the touch pad.

FIG. 7 is a diagrammatic view of a third embodiment one way of dividing the touch area on the touch pad.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “untouchable” means that all touch functions can not be used by a user even if the user touches a touch pad. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

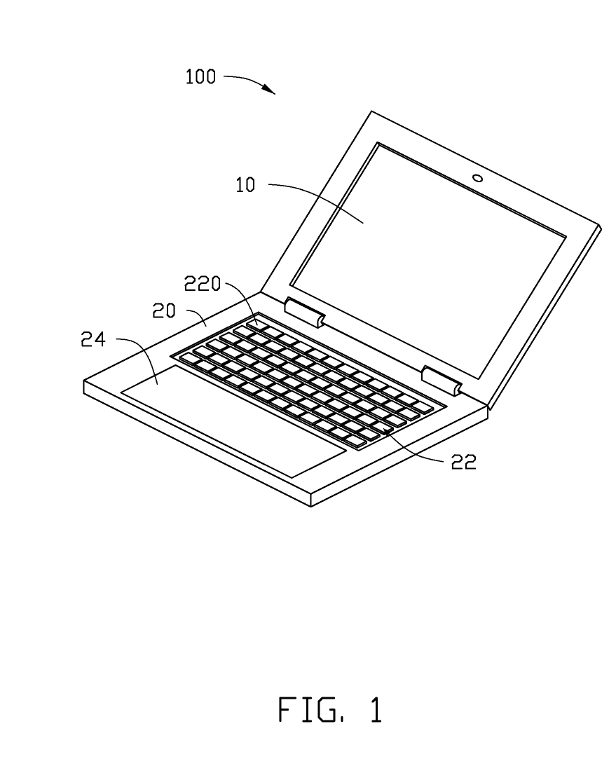

Referring to FIG. 1, one embodiment of a portable computer 100 includes a display 10 and a base assembly 20 connected with the display 10. The base assembly 20 includes a keyboard 22 and a touch pad 24. The keyboard 22 includes a plurality of keys 220. The touch pad 24 defines a touch area.

The base assembly 20 defines a surface and two opposite sides. The surface faces the display 10. The keyboard 22 and the touch pad 24 are disposed on the surface. The keyboard 22 extends from one of the two opposite sides to the other one of the two opposite sides. The touch pad 24 is disposed below the keyboard 22. The touch pad 24 can be a large-sized touch pad having a substantially same length to the keyboard 22. In other words, the touch pad 24 can extend from one of the two opposite sides to the other one of the two opposite sides, whereby the entire surface of the base assembly 20 is covered by the keyboard 22 and the touch pad 24. The touch pad 24 with the large size can accomplish various touch operations, such as but not limit to, cursor controlling, gesture controlling, handwriting, or painting. Different regions of the touch area can be used to accomplish different touch operations. The touch pad 24 can be but not limited to a capacitive touch pad or a resistive touch pad. The portable computer 100 can be but not limited to a notebook computer, laptop computer, or a notepad computer.

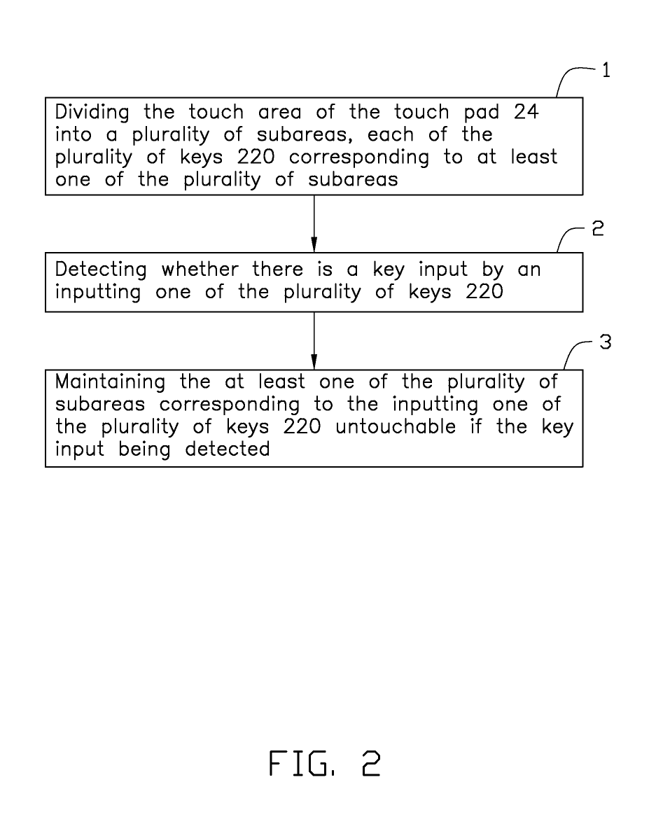

Referring to FIG. 2, one embodiment of a method for preventing a false activation of the touch pad 24 of the portable computer 100 includes the following steps:
Block 1, dividing the touch area of the touch pad 24 into a plurality of subareas, each of the plurality of keys 220 corresponding to at least one of the plurality of subareas;
Block 2, detecting whether there is a key input by an inputting one of the plurality of keys 220; and
Block 3, maintaining the at least one of the plurality of subareas corresponding to the inputting one of the plurality of keys 220 being untouchable if the key input being detected.

In block 1, the touch area covers an entire surface of the touch pad 24. The plurality of subareas cooperatively covers the entire surface of the touch pad 24. Each of the plurality of key 220 corresponds to the at least one of the plurality of subareas, whereby a corresponding relationship is built between each of plurality of keys 220 and the at least one of the plurality of subareas. When a user inputs by pressing one or more of the plurality keys 220, palms of the user may rest on some specific regions of the touch area. The palm rest may cause a false activation of the touch pad 24 and the false activation can disturb the input by the one or more of the plurality of keys 220. The corresponding relationship is to correspond the pressed one or more of the plurality of keys 220 to palm rest regions of the touch area. The palm rest regions can be the subareas corresponding to the pressed one or more of the plurality of keys 220.

In block 3, when user is inputting by the one or more keys 220, the at least one of the plurality of subareas corresponded to the pressed key 220 are found out and acted as an untouchable subarea which is locked to maintain untouchable. The term “untouchable” means that the touch pad 24 in the untouchable subarea is locked and no touch functions will be responded even when there is touch acted on the untouchable subarea, but a touch information in the untouchable subarea will be detected continuously.

The corresponding relationship can be built according to positions of the plurality of keys 220. The keyboard 22 can be divided into a plurality of sub-blocks along a direction extending the length of the keyboard 22. Each of the plurality of sub-blocks includes some of the keys 220 and each of the keys 220 is located in one of the plurality of sub-blocks. The plurality of sub-blocks can be adjoined in sequence and not overlap with each other. Each of the plurality of sub-blocks can correspond to the at least one of the plurality of subareas along the length extending direction of the keyboard 22. In one embodiment, the sub-block at a left side of the keyboard 22 can correspond to the subarea at a left side of the touch area, the sub-block at a right side of the keyboard 22 can correspond to the subarea at a right side of the touch area, and the sub-block at a center of the keyboard 22 can correspond to the subarea at a center of the touch area.

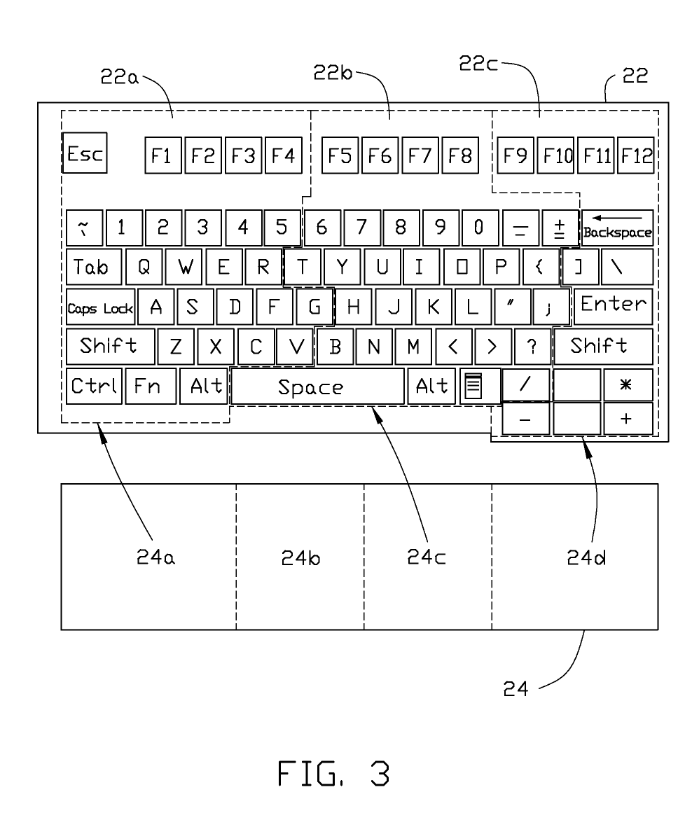

Referring to FIG. 3, one embodiment of the corresponding relationship can be illustrated. The keyboard 22 of the portable computer 100 is a standard QWERTY keyboard. The touch area is divided into four subareas 24a, 24b, 24c, and 24d. The keyboard 22 is divided into three sub-blocks 22a, 22b, and 22c. The sub-block 22a corresponds to the subarea 24a, whereby the keys 220 located in the sub-block 22a, such as keys Q, W, E, and A, correspond to the subarea 24a. Similarly, the keys 220 located in the sub-block 22b correspond to the subarea 24c and the keys 220 located in the sub-block 22c correspond to the subarea 24d. If one or more of the keys 220 are pressed, the corresponded subareas are locked to remain untouchable.

The plurality of subareas 24 can include easy palm rest regions and uneasy palm rest regions. The palms of the user easily rest on the easy palm rest regions when inputting by the keys 220. The palms of the user rarely rest on the uneasy palm rest regions when inputting by the keys 220. The uneasy palm rest regions can be touchable at all times. Referring to FIG. 3, the subarea 22b commonly is the uneasy palm rest region and can be touchable at all times.

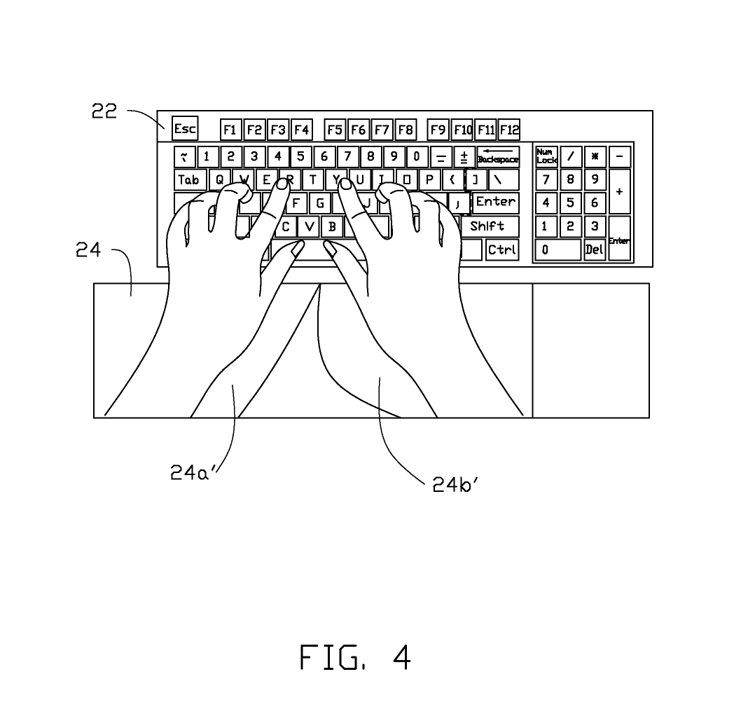

Amounts, shapes, and sizes of the plurality of subareas or the sub-blocks can be set according a detection precision of a required false activation. The more and the smaller the plurality of subareas are, the more precisely the false activation can be detected. In one embodiment, the amounts, shapes, and sizes of the plurality of subareas or the sub-blocks can be set according to users' habits when typing by the keys 220. The shape of the plurality of subareas can be at least one of rectangle, inverted trapezoid, and any other combination shapes formed by lines and curves. Referring to FIG. 4, the shape of some of the plurality of subareas is the inverted trapezoid of which at least one side is an arc line to suit the palms or elbow of the user when typing by the keys 200, such as the subareas 24a and 24b.

The size of each of the plurality of subareas can be set upon a palm width of the user, thereby, a false activation areas of the touch pad 24 caused by palm rest when typing can be precisely defined. In one embodiment, a width of the subareas in the easy palm rest region substantially equals to the palm width. Sizes among the plurality of subareas can be same or different. In one embodiment, the sizes of the plurality of subareas are different. The amount of the subareas in the easy palm rest region can be set more than that of the subareas in the uneasy palm rest region and the size of the subareas in the easy palm rest region can be smaller than that of the subareas in the uneasy palm rest region. The false activation can be effectively detected and avoided this way. In one embodiment, the amount of subareas at a left side and a right side of the touch area along the length extending direction are more than that of the subareas at a center of the touch area, and furthermore, the size of the subareas at the left side and the right side of the touch area is smaller than that of the subareas at the center of the touch area.

The plurality of subareas can be divided by various ways. In one embodiment, the touch area is divided into six subareas 24a, 24b, 24c, 24d, 24e, and 24f just for a better illustration.

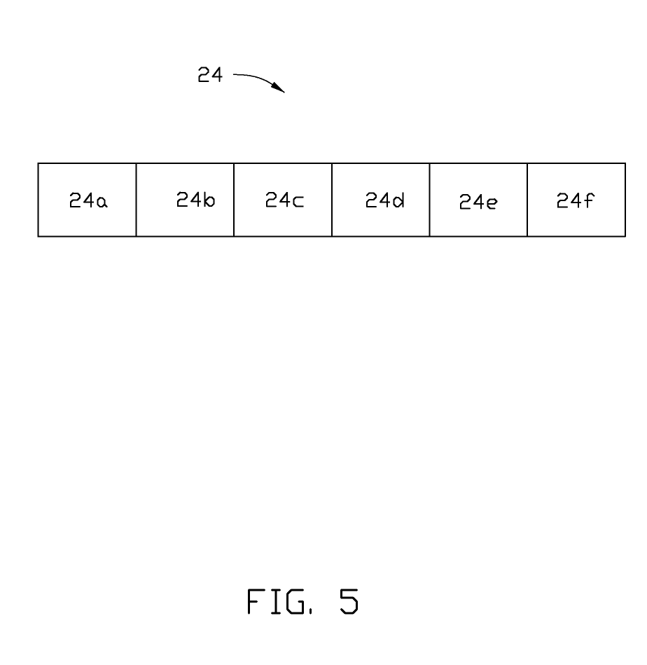

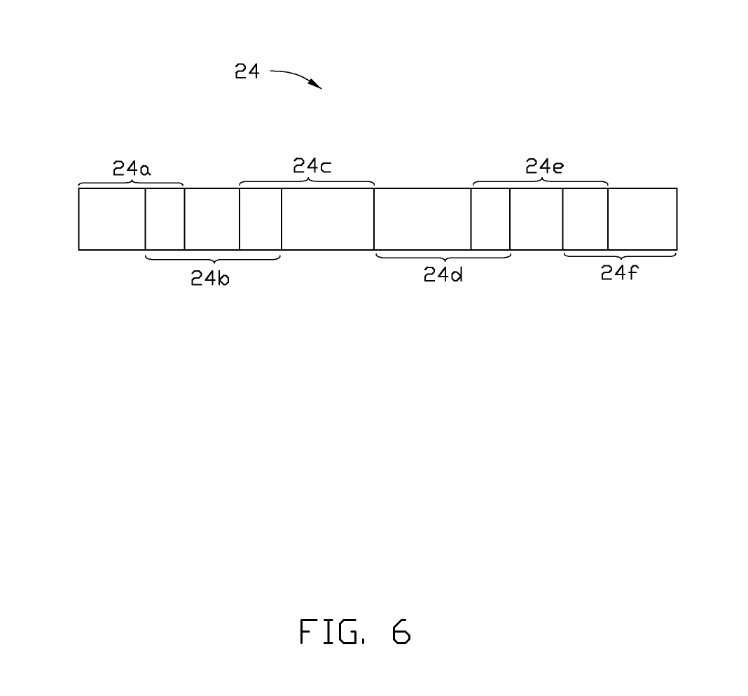

Referring to FIG. 5, in one embodiment, the plurality of subareas can adjoin in sequence along the length extending direction of the touch pad 24 and can be arranged not to overlap with each other. Referring to FIG. 6, in one embodiment, at least two adjacent subareas are partially overlapped. The palm of the user may be rested on a boundary of two adjacent subareas when inputting using the keys 220, therefore, the detection precision for the false activation of the touch pad 24 can be increased by setting the partially overlapped subareas. In one embodiment, the partially overlapped subareas can be the easy palm rest regions of the touch pad 24. The plurality of subareas can include central subareas and side subareas. In one embodiment, the side subareas are the easy palm rest regions. Two adjacent subareas of the side subareas can be partially overlapped. In addition, the central subareas are always the uneasy palm rest regions and can only adjoin and are arranged not to overlap with each other. Referring to FIG. 6, the side subareas 24a, 24b, and 24c are the easy palm rest regions and adjoin and partially overlap with each other, the side subareas 24d, 24e, and 24f also are the easy palm rest regions and adjoin and partially overlap with each other, and the subareas 24c and 24d only adjoin but do not overlap with each other for the central subareas are the uneasy palm rest regions, whereby a detection efficiency of the false activation can be improved.

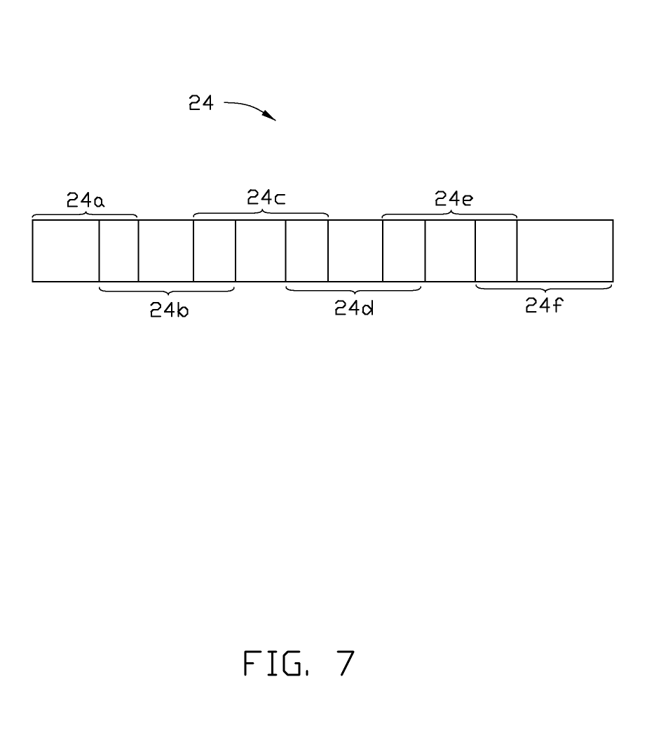

Referring to FIG. 7, in one embodiment, every two adjacent subareas can partially overlap with each other to ensure the false activation of the touch pad 24 being located in at least one of the plurality of subareas. Whereby the false activation of the touch pad 24 can be easily and precisely detected.

Furthermore, the method further includes a step of setting a lock time period T_{lock} to maintain the untouchable subarea untouchable within the lock time period T_{lock}. The lock time period T_{lock} starts timing since from one of the subarea is locked to maintain untouchability. If a time period of the subarea being untouchable exceeds the lock time period, the key input is further detected. If there is still no key input being detected, the untouchable subarea will be activated to be touchable.

The user's palm resting on the touch pad 24 may slightly move when typing by the keyboard 22. This kind of palm rest is still considered as the false activation of the touch pad 24. The set lock time period T_{lock} can reduce a scanning frequency for judging the untouchable subarea to be touchable or untouchable. In addition, the set lock time period T_{lock} can avoid a false judgment, such as falsely activating the untouchable subarea to be a touchable subarea, caused from variations of sensing signals detected from the touch pad 24 in a short time. The lock time period T_{lock} is a time value in a range from about 0.5 second to about 1 second.

The method disclosed above, on one hand, can effectively and precisely avoid the false activation by the palm rest when inputting by the keys of the keyboard. On the other hand, the method can maintain a correct response for a single or multiple-touch acting on the touch pad at the same time in the touchable subareas.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A method for preventing a false activation of a touch pad of a portable computer, the portable computer comprising a display and a base assembly, the base assembly comprising a keyboard and the touch pad, the keyboard comprising a plurality of keys, the touch pad defining a touch area, the method comprising:
dividing the touch area into a plurality of subareas, each of the plurality of keys corresponding to at least one of the plurality of subareas;
detecting whether there is a key input by an inputting one of the plurality of keys; and
maintaining the at least one of the plurality of subareas corresponded to the inputting one of the plurality of keys being untouchable if the key input is detected.

2. The method of claim 1, wherein the touch area comprises easy palm rest regions and uneasy palm rest regions, palms of a user easily rest on the easy palm rest regions when inputting by the plurality of keys, the palms of the user barely or rarely rest on the uneasy palm rest regions when inputting by the plurality of keys, and the easy palm rest regions are set as some of the plurality of subareas corresponding to the plurality of keys.

3. The method of claim 1, wherein the base assembly defines a surface and two opposite sides, the keyboard and the touch pad covers the entire surface of the base assembly and both the keyboard and the touch pad extend from one of the two opposite sides to the other one of the two opposite sides along a length extending direction.

4. The method of claim 1, wherein the plurality of subareas comprise left side subareas, right side subareas, and central subareas along a length extending direction of the touch area, an amount of the left side subareas and the right side subareas is more than that of the central subareas.

5. The method of claim 4, wherein a size of the left subareas and the right side subareas is smaller than that of the central subareas.

6. The method of claim 1, wherein the plurality of subareas covers the entire touch area.

7. The method of claim 1, wherein the plurality of subareas adjoin in sequence and at least two adjacent of the plurality of subareas partially overlap with each other.

8. The method of claim 1, wherein the plurality of subareas comprise left side subareas, right side subareas, and central subareas along a length extending direction of the touch area, the left side subareas are partially overlapped with each other, the right side subareas are partially overlapped with each other, and the central subareas adjoin but do not overlap with each other.

9. The method of claim 1, wherein the plurality of subareas adjoin in sequence and every two adjacent to the plurality of subareas partially overlap with each other.

10. The method of claim 1 further comprising a step of setting a lock time period to keep at least one untouchable subarea of the plurality of subareas to be untouchable within the lock time period.

11. The method of claim 10 further comprising further detecting the key input if a time period of the at least one untouchable subarea being untouchable exceeds the lock time period, if there is still no key input detected, activating the at least one untouchable subarea to be touchable.

12. The method of claim 10, wherein the lock time period is a value in a range from about 0.5 seconds to about 1 second.
